(19) United States
(12) Patent Application Publication
(10) Pub. No.: US 2001/0002289 A1
(43) Pub. Date: May 31, 2001

(54) PROCESS FOR THE AT LEAST PARTIAL, DIRECT COATING OF AN EXTENSIBLE BACKING MATERIAL WITH A PRESSURE-SENSITIVE ADHESIVE COMPOSITION

(76) Inventors: PETER HIMMELSBACH, BUXTEHUDE (DE); PETER JAUCHEN, HAMBURG (DE); KLAUS KEITE-TELGENBUSCHER, HAMBURG (DE); MATTHIAS LEHDER, BUCHHOLZ (DE)

Correspondence Address: NORRIS, McLAUGHLIN & MARCUS P.A., 220 EAST 42ND STREET-30TH FLOOR, NEW YORK, NY, 10017, US

(21) Appl. No.: 09/205,622

(22) Filed: Dec. 4, 1998

(30) Foreign Application Priority Data
Dec. 13, 1997 (DE) 197 55 436.9

(51) Int. Cl. B05D 5/10; B05D 1/28

(52) U.S. Cl. 427/598; 427/428; 427/208.6

(57) ABSTRACT

Process for the at least partial, direct coating of an extensible backing material with a pressure-sensitive adhesive composition, the backing material being guided by a transporting apparatus against a coating apparatus in such a way that the latter applies the pressure-sensitive adhesive composition to the backing material, characterized in that there are adhesion devices or holding devices present on the transporting apparatus so that the properties of the backing are not altered in the course of coating.

The invention relates to a process for the at least partial, direct coating of an extensible backing material with a pressure-sensitive adhesive composition, the backing material being guided by a transporting apparatus against a coating apparatus in such a way that the latter applies the pressure-sensitive adhesive composition to the backing material.

The use of extensible, particularly textile, materials as backings having elastic or plastically formable properties is known in both industry and medicine. They are used in a wide variety of areas—inter alia, as base materials in the production of plasters and adhesive dressings.

The term “plastically or elastically deformable” is intended to denote the extensibility of a material. In accordance with this a material is extensible if under a load of 10 N/cm it exhibits an increase in length of at least 20%.

It is also known that the extensible backing materials can be coated with various adhesive systems. In general, coating can be performed over the whole area or else partially. With medical, self-adhesively treated backing materials it is found in the case of partial coating that, given appropriately porous backing materials, the result is a highly air-permeable and water-vapour-permeable film which in general can also be detached fairly easily again after it has been bonded to the skin of the patient.

Half-tone printing is widespread as a process for producing such partially coated backing materials, and especially, screen, gravure or flexographic printing. It is also known that the self-adhesive treatment can also be applied to more than one side, in the case, for example, of use as fixings.

The adhesive compositions which can be used are, in principle, solvent-based or dispersion-based systems, or else 100% systems. When processing the 100% systems it is an advantage that there is no need to remove the solvents or dispersion auxiliaries. This increases the productivity and at the same time reduces the expenditure on machinery and the energy costs.

Elastic or plastically formable backing materials can generally be coated directly or indirectly. In the case of indirect coating, a preferably rigid or fairly nonelastic auxiliary support is coated first of all and then the adhesive composition is transferred in a laminating process to the elastic or plastically formable backing. For indirect coating it has been found advantageous that in this case the backing material can be laminated essentially without deformation and prior loading, so leading to the extensive retention of shape and of technological features such as basis weight, maximum tensile strength, extension under maximum tension, and hysteresis extension.

The disadvantage of indirect coating lies in the relatively poor anchorage of the adhesive composition to the elastic or plastically deformable backing. Here it is found that, especially in the case of temperature-sensitive backing materials, thermal lamination is impossible or largely unsuccessful. In the case of thick, porous backing materials, lamination may be accompanied by the adhesive film being pressed completely into the backing, with the consequence of a drastic deterioration in both the bonding properties and the elasticity.

Direct coating, although it permits a much improved anchorage of the adhesive composition, entails greater stress on the backing mechanically and, where pressure-sensitive hotmelt adhesive compositions are used, thermally as well. Especially in the case of partial application of adhesive composition to an at least partially elastically or plastically formable backing material it is found that this material, although the backing is placed unstressed and undeformed into the coating unit, is stressed in some cases to such an extent that there is an irreparable change in its properties. This is a consequence of the fact that the adhesive system adheres to the coating unit with a system-dependent force.

In order to separate the self-adhesively treated backing from this coating unit, it is necessary to exert a force on the backing. In accordance with the prior art this is done by an appropriately high web tension force on the extensible backing, as a result of which the latter experiences an impairment of its properties, especially its elasticity and basis weight.

The object of the invention was to develop a direct coating process which makes it possible to coat an extensible backing material at least partially with a pressure-sensitive adhesive composition without altering the properties of the backing.

This object is achieved by a process as described in more detail in claim 1. The subclaims represent advantageous embodiments.

Accordingly, in the process of the invention for the at least partial, direct coating of an extensible backing material with a pressure-sensitive adhesive composition, the backing material is guided by means of a transporting apparatus against a coating apparatus in such a way that the latter applies the pressure-sensitive adhesive composition to the backing material, there being adhesion devices or holding devices present on the transporting apparatus. The forces required for guidance to and for separation from the coating unit are applied by these devices in such a way that are not altered in the course of coating.

In one advantageous embodiment of the process, the backing material is coated over its whole area.

The holding apparatuses consist preferably of needles which project from the transporting apparatus and engage in the backing material.

In this case the needles advantageously have a length greater than 10 μm, preferably between 30 μm and 5000 μm and, with particular preference, between 35 μm and 1000 μm.

The distance between the tips is preferably greater than 60 μm and is dependent on the nature of the backing.

In addition, the needles can at least in part be mobile on the surface of the transporting apparatus.

One particular embodiment of the needles is that of a touch-and-close connection, where the needles are provided with barbs.

A further advantageous embodiment of the holding apparatus on the transporting apparatus consists in the use of very rough surfaces i.e. in a generally unordered arrangement of geometries suitable for engagement in the extensible backing.

The roughened surface can be formed from applied particles of hard material and/or of a metal, ceramic or plastic surface roughened by the shaping procedure or by means of mechanical, physical or chemical treatment.

Mention may be made here by way of example of coatings of corundum or similar hard materials, which have a sandpaper-like surface. Alternatively, metal surfaces roughened by etching or other techniques are appropriate.

The peak-to-valley roughness of the surface is advantageously between 30 and 5000 μm.

An alternative option is the use of holding apparatuses which are active through forces of adhesion; for example, the use of a self-adhesive composition whose adhesive force is tailored to the system as a whole.

For appropriate backing materials, electromagnetic fields are also suitable for applying the holding forces.

In a particularly preferred embodiment the transporting apparatus consists of a treated transport roller and the coating apparatus of a rotating, heated, seamless, drum-shaped and perforated cylindrical screen which is fed via a nozzle with the pressure-sensitive hotmelt adhesive composition or with the pressure-sensitive adhesive dispersion, the pressure-sensitive adhesive systems being applied by way of a nozzle lip through the cylindrical screen and onto the backing material that is conveyed past it.

The transport roller can consist preferably of metal, ceramic or plastic. It can be generally plastic, elastic or rigid in configuration.

Depending on the target application it is possible to configure the roller such that the roughness and/or the needles or the alternative solutions proposed are present uniformly, randomly distributed or in a defined geometric pattern on the roller surface. The geometric form and extent of the adhesion elements are also adapted to the backing. The configuration of needle orientation has also been found advantageous. For specific uses, the angle of needle orientation can be between 10° and 170° to the tangent to the surface of the roller in the coating direction and also between 10° and 170° perpendicular to the coating direction. The needles can, moreover, be designed at least in part to be mobile, so that their orientation and/or size may change during one revolution of the transport roller as a result, for example, of exposure to a magnetic field or of eccentric constructions.

The coating apparatus and/or the holding apparatuses have preferably received an anti-adhesive treatment, especially by means of silicones or fluorine compounds or plasma-coated release systems, it being possible to apply the anti-adhesive layer on the coating apparatus with a weight per unit area of from 0.001 g/m² to 350 g/m², preferably between 0.01 g/m² and 10 g/m².

In addition, the surface of the transport roller and/or of the adhesion elements can be pretreated both physically and chemically. By way of example, mention may be made here of siliconization and of conventional Teflonization. A static or else antistatic treatment may give rise to applications-related advantages. Techniques for applying such release coverings are adequately described in the technical literature, with examples being dipping, electrolysis, brushing, spraying and printing. The release coverings can be cured both physically and chemically. Chemically curing systems, for example, have been found advantageous for the processing of hotmelt adhesive compositions.

The process will be described by way of example on the principle of thermal screen printing, without wishing thereby to restrict the invention unnecessarily.

The principle of thermal screen printing consists in the use of a rotating, seamless, drum-shaped, perforated, cylindrical screen which is fed via a nozzle with the pressure-sensitive hotmelt adhesive composition. A specially shaped nozzle lip (circular- or square-section coating bar) presses the self-adhesive composition, which is fed in via a channel, through the perforation of the screen wall and onto the backing web that is conveyed past it. This backing web is guided by means of a counterpressure roller against the external jacket of the heated screen drum at a rate which corresponds to the peripheral speed of the rotating screen drum.

This counterpressure roller is equipped with a needled surface such that it is able to exert a force which is oriented in a directionally dependent manner in such a way that it is slightly greater than the force of adhesion of the cooling adhesive melt to the screen drum surface.

The backing web is removed from the counterpressure roller by means of a perpendicularly directed air stream.

The formation of the domes of adhesive remains unaffected by the above-mentioned apparatuses and, in the case of the preparation of the partially coated elastic or plastically deformable backing material, takes place in accordance with the following mechanism:

The pressure of the nozzle coating bar conveys the pressure-sensitive hot melt adhesive composition through the screen perforation onto the backing material. The size of the domes formed is predetermined by the diameter of the screen perforation. The screen is lifted from the backing in accordance with the rate of transportation of the backing web (rotary speed of the screen drum). As a consequence of the high adhesion of the pressure-sensitive hotmelt adhesive composition and of the internal cohesion of the hotmelt, the limited supply of pressure-sensitive hot melt adhesive composition in the perforations is drawn in sharp definition from the base of the domes that is already adhering to the backing and is conveyed onto the backing by the pressure of the coating bar.

Following the end of this transportation, the more or less highly curved surface of the dome is formed over the predefined base area in dependence on the rheology of the pressure-sensitive hot melt adhesive composition. The height-to-base ratio of the dome depends on the ratio of the perforation diameter to the wall thickness of the screen drum and on the physical properties (flow behaviour, surface tension and contact angle with the backing material) of the self-adhesive composition.

The above-described mechanism of formation of the domes requires, preferentially, backing materials that are absorbent or at least wettable by pressure-sensitive hot melt adhesive composition.

Non-wetting backing surfaces must be pretreated by chemical or physical methods. This can be effected by means of additional measures such as corona discharge or by coating with substances which improve wetting.

Using the printing technique indicated it is possible to lay down the size and shape of the domes in a defined manner. The adhesive force values which are relevant for use, and which determine the quality of the products formed, are within very narrow tolerances provided that coating is carried out correctly. The base diameter of the domes can be chosen to be from 10 to 5000 μm, the height of the domes from 20 to about 2000 μm, preferably from 50 to 1000 μm, the low-diameter range being intended for smooth backings and the range of greater diameter and greater dome height being intended for rough or highly porous backing materials.

The positioning of the domes on the backing is laid down in a defined manner by the geometry of the applicator unit, for example the gravure, screen or nozzle geometry. With the aid of the parameters indicated it is possible, by way of adjustable variables, to establish with very great precision the desired profile of properties of the coating, harmonized with the various backing materials and applications.

The backing material is preferably coated at a rate of more than 2 m/min, preferably from 20 to 100 m/min, the chosen coating temperature being greater than the softening temperature.

### EXAMPLE 1

Elastic medical bandages were coated directly.

By means of the disclosed invention it was possible to omit the auxiliary support for indirect coating and to omit the environmentally compatible recovery of the solvent, which is costly and entails high mechanical expenditure. The bandage was coated by thermal screen printing with 160 g/m² of an adhesive composition based on a block copolymer.

The block copolymer was a styrene-ethylene-butylene-styrene block copolymer to which paraffinic hydrocarbon waxes had been added. The proportion was one part of polymer to one part of paraffinic hydrocarbon. 10% of polystyrene resin (Amoco 18240) was added to this mixture. The adhesive contained one percent of Irganox, an anti-ageing agent (n-octadecyl β-(3,5 di-t-butyl-4-hydroxyphenyl)propionate), and further hydrocarbon resins and fatty acid esters, which were present only in small amounts in the overall adhesive. The softening point of this adhesive composition was 100° C. (DIN 52011) and its glass transition temperature, determined by the above mentioned method, was −6° C.

The following characteristic values for the elastic and plastic properties of the bandage were measured:

| | Conventional direct | |
|---|---|---|
| | thermal screen | Novel direct thermal |
| | printing | screen printing |
| Extension at | 45% | 87% |
| 10 N/cm | | |
| Plastic | 25% | 25% |
| deformation | | |
| at 10 N/cm | | |

The high level of application of the composition was achieved using a 14-mesh screen. The use of the large coating dots made it possible to obtain good adhesion to the backing, and clean cutting.

The holding apparatus used was a needle roller which had 25 needles/cm². The length of the needles was 0.25 mm. The adhesive composition was skin-compatible and showed good adhesion to the skin and to the reverse of the backing.

The bandage produced in this way, even in a multi-ply dressing, was permeable to air (more than 15 cm³/(cm²*s)) and permeable to water vapour (more than 1500 g/(m²*24 h)).

The elastic adhesive bandage was used for compression, support and relief dressings, where the high initial and long-term bond strength and the shear strength were advantageous. The shapeability and sensation obtained by the user were improved as a result of the partial application of the adhesive composition.

1. Process for the at least partial, direct coating of an extensible backing material with a pressure-sensitive adhesive composition, the backing material being guided by a transporting apparatus against a coating apparatus in such a way that the latter applies the pressure-sensitive adhesive composition to the backing material, characterized in that there are adhesion devices or holding devices present on the transporting apparatus so that the properties of the backing are not altered in the course of coating.

2. Process according to claim 1, characterized in that the backing material is coated over its whole area.

3. Process according to claim 1, characterized in that the holding apparatuses consist of needles which project from the transporting apparatus and engage in the backing material.

4. Process according to claim 3, characterized in that the needles have a length greater than 10 μm, preferably between 30 and 5000 μm and, with particular preference, between 35 and 1000 μm.

5. Process according to claim 3, characterized in that the needles are at least in part mobile on the surface of the transporting apparatus.

6. Process according to claim 3, characterized in that the needles are provided with barbs.

7. Process according to claim 1, characterized in that the holding apparatuses on the transporting apparatus consist of a roughened surface whose roughness geometries engage in the backing material.

8. Process according to claim 6, characterized in that the peak-to-valley roughness of the surface is between 30 and 5000 μm.

9. Process according to claim 6, characterized in that the roughened surface consists of applied particles of hard material and/or of a metal, ceramic or plastic surface roughened by the shaping procedure or by means of mechanical, physical or chemical treatment.

10. Process according to claim 1, characterized in that the holding apparatus on the transporting apparatus consists of a self-adhesive surface whose forces of adhesion act on the backing material.

11. Process according to claim 1, characterized in that the holding apparatuses on the transporting apparatus consist of electromagnetic fields whose forces act on the backing material.

12. Process according to claim 1, characterized in that the transporting apparatus consists of a treated transport roller and the coating apparatus of a rotating, seamless, drum-shaped and perforated cylindrical screen which is fed via a nozzle with the pressure-sensitive hotmelt adhesive composition or with the pressure-sensitive adhesive dispersion, both pressure-sensitive adhesive systems being applied by way of a nozzle lip through the cylindrical screen and onto the backing material that is conveyed past it.

13. Process according to claim 12, characterized in that the coating apparatus and/or holding apparatuses have received an anti-adhesive treatment, preferably by means of silicones or fluorine compounds or plasma-coated release systems.

14. Process according to claim 13, characterized in that the anti-adhesive layer on the coating apparatus has a weight per unit area of from 0.001 to 350 g/m², preferably between 0.01 and 10 g/m².
